(19) United States
(12) Patent Application Publication
(10) Pub. No.: US 2013/0080794 A1
(43) Pub. Date: Mar. 28, 2013

(54) WIRELESS CONTROLLER WITH UNIVERSAL SERIAL BUS AND SYSTEM HAVING THE SAME

(71) Applicant: CHIN-HSUEH HSIEH, Taipei City (TW)

(72) Inventor: CHIN-HSUEH HSIEH, Taipei City (TW)

(73) Assignee: JAWBONE INDUSTRIAL CO., LTD., NEW TAIPEI CITY (TW)

(21) Appl. No.: 13/244,412

(22) Filed: Sep. 24, 2011

(51) Int. Cl. G06F 1/26; G06F 3/00

(52) U.S. Cl. 713/300; 710/17

(57) ABSTRACT

A wireless controller with a universal serial bus (USB) and a system having the same are disclosed. The wireless controller with the USB includes an input unit, a detection unit, and a wireless transmission module. The input unit is configured to receive the data signal from the main device while the detecting unit that is coupled to the input unit is configured to detect the data signal before generating a corresponding control signal, which may be in turn transmitted by the wireless transmission module. Depending on the control signal, sockets in a power socket device may be powered or not. Accordingly, auxiliary device plugged to the socket may be powered or not powered when an operating status of a main device varies.

### BACKGROUND OF THE INVENTION

1. Field of the Invention

The present invention relates to a wireless controller, and more particularly, to a wireless controller with a universal serial bus (USB) and a system having the same.

2. Description of Related Art

As the technology progresses, electronic devices have been widely utilized in people's daily lives. People even take pride in controlling multiple electronic devices at the same time. And for the multiple electronic devices to operate properly and simultaneously a reliable power source supply for each and every electronic device is critical. Therefore, a power extension cord has been developed for serving as one of the reliable source of distributing the power from a power source to the multiple electronic devices plugged to the power extension cord.

When the electronic device is no longer in need of operation and unplugged from the power extension cord, the power extension cord may avoid being burned down and less power may be consumed by the electronic device. Plugging and unplugging the electronic device from the power cord extension for too many times, however, may damage the plug of the electronic device. Therefore, if the power supply for the electronic device is controllable regardless of whether such electronic device is plugged to or unplugged from the power extension cord more power consumption could be saved and the electronic device may enjoy the longer shelf life.

To achieve the aforementioned goal, a power extension cord that is capable of accurately detecting the operation of the electronic device has been introduced. More specifically, the introduced power extension cord detects a voltage signal at a universal serial bus of a computer system. When the detected voltage signal is at 5 volts, indicative of the computer system is in a normal operating mode, the power extension cord may continue the power supply to the socket to which the computer system is plugged. And when the detected voltage signal is at 0 volt, which suggests the computer system is no longer in the normal operating mode, the power extension cord could stop supplying the power to that particular socket. The aforementioned power extension cord, however, fails to take into account that the computer system operates in other modes such as standby mode and hibernation mode when the detected voltage signal could be remaining at 5 volts. As such, the power extension cord may continue its power supply to the socket when the computer system operates in the standby mode and the hibernation mode, resulting in unnecessary power consumption.

### SUMMARY OF THE INVENTION

The primary objective of the present invention is to provide a wireless controller with a universal serial bus (USB) and a system having the same. The wireless controller of the present invention may detect an operating status of a main device on basis of a data signal transmitted from the main device. With the operating status of the main device, the wireless controller according to the present invention may thus control an operating status of an auxiliary device.

In order to achieve the aforementioned objective, according to one embodiment of the present invention, the wireless controller may include an input unit, a detection unit, and a wireless transmission module. The input unit is configured to receive the data signal from the main device while the detecting unit that is coupled to the input unit is configured to detect the data signal before generating a corresponding control signal, which may be in turn transmitted by the wireless transmission module.

In one implementation, the data signal from the main device is a differential signal of the USB.

The present invention further discloses the wireless controller system having the wireless controller with the USB and a power socket device. The wireless controller may include the input unit, the detecting unit, and the wireless transmission module, while the power socket device may include a plurality of sockets, a power input unit, a wireless reception module, and a switching unit.

The input unit is configured to receive the data signal from the main device with the detecting unit coupled to the input unit and detecting the data signal for generating the control signal. The wireless transmission module is configured to transmit the control signal. The power input unit, meanwhile, is configured to provide power supply with the socket while coupling to a city power. The wireless reception module is configured to receive the control signal and the switching unit is coupled to the power input unit, the socket, and the wireless reception module. The switching unit may thus selectively connect the power input unit to the socket depending on the control signal.

The switching unit may switch between a power supply mode and a power stoppage mode. When the control signal corresponds to the power supply mode, the power input unit and the socket connect with each other. On the other hand, when the control signal corresponds to the power stoppage mode the power input unit is disconnected from the socket.

To sum up, the wireless controller system is capable of detecting the data signal of the main device before controlling whether the auxiliary device plugged to the socket should be connected to the power input unit. Therefore, the unnecessary power consumption when the main device is no longer operating routinely (e.g., operating in a hibernation mode) may be reduced.

In order to further the understanding regarding the present invention, the following embodiments are provided along with illustrations to facilitate the disclosure of the present invention.

### BRIEF DESCRIPTION OF THE DRAWINGS

FIG. 1 shows a simplified block diagram of a wireless controller system with a USB according to an embodiment of the present invention;

FIG. 2 shows a simplified block diagram of a wireless controller system with a USB according to another embodiment of the present invention;

FIG. 3 illustrates a simplified block diagram of a wireless controller with a USB 3 according to one embodiment of the present invention; and

FIG. 4 shows a simplified block diagram of a power socket device.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### Embodiment for Wireless Controller with USB

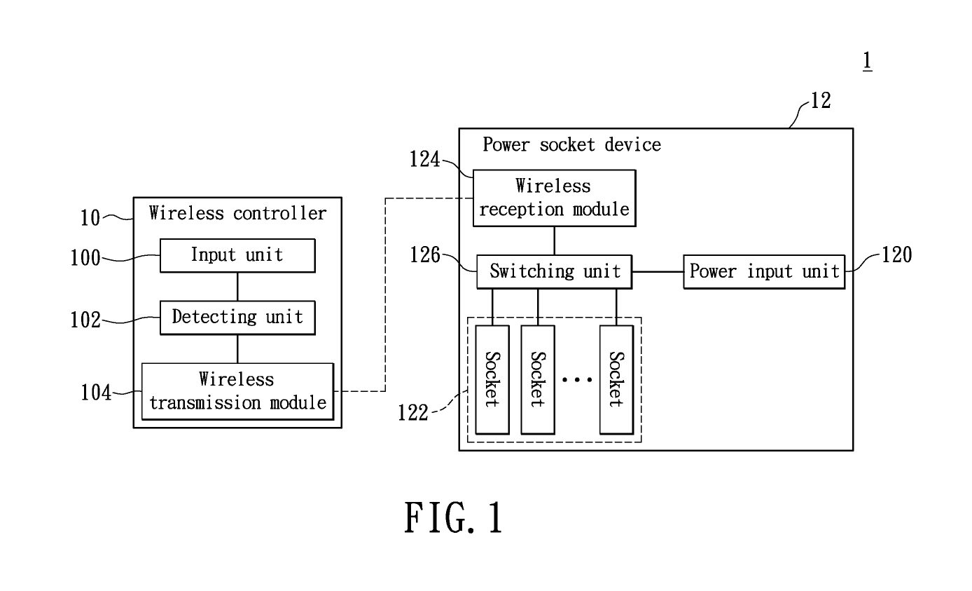

Referring to FIG. 1 in which a simplified block diagram of a wireless controller system with a USB 1 according to an embodiment of the present invention is illustrated. The wireless controller system with the USB 1 includes a wireless controller 10 and a power socket device 12. The wireless controller 10 further includes an input unit 100, a detecting unit 102, and a wireless transmission module 104, while the power socket device 12 includes a power input unit 120, a plurality of sockets 122, a wireless reception module 124, and a switching unit 126.

The detecting unit 102 may be coupled between the input unit 100 and the wireless transmission module 104. The switching unit 126 may be coupled between the power input unit 120, the wireless reception module 124, and the sockets 122.

As shown in FIG. 1, the wireless controller 10 may be configured to receive a data signal of a main device (not shown) by the input unit 100 with the data signal indicative of an operating status of the main device. And when the wireless controller 10 receives the data signal the wireless controller 10 may transmit a corresponding control signal to the power socket device 12. It is worth noting that the type of the input unit 100 is not intended to be limited in the present invention so long as the selected input unit is capable of transmitting the data signal. For example, the input unit 100 may be a USB connector. In another implementation, the input unit 100 may be a RS-232 connector, a RS-485 connector, a RS-422 connector, an IEEE-1394 connector, or connectors of other varieties. When the input unit 100 is the USB connector, the main device transmit the data signal from a first data line (D+) or a second data line (D−).

The detecting unit 102 based on the received data signal from the input unit 100 may generate the control signal, which may be further transmitted by the wireless transmission module 104. In practice, the control signal may be generated to indicate that the main device operates routinely. Additionally, no control signal may be generated by the detecting unit 102 when no data signal is received, or the main device is in the hibernation mode or has been shut down. And only when the control signal is generated for indicating the main device operates routinely the detecting unit 102 may instruct the power socket device 12 to supply the power to an auxiliary device. As previously mentioned, since the main device transmit the data signal from the first data line (D+) or the second data line (D−) when the input unit 100 receives the data signal from the first data line (D+) or the second data line (D−) and relays the same to the detecting unit 102 the detecting unit 102 may generate the control signal accordingly.

The wireless transmission module 104 may be configured to receive the control signal from the detecting unit 102 before transmitting the same to the wireless reception module 124 of the power socket device 12. In one implementation, the wireless transmission module 104 may be a radio frequency (RF) module and the wireless reception module 124 may be a module that is capable of receiving RF-based control signal. In another implementation, the wireless transmission module 104 may be an infrared transmission module, a Bluetooth transmission module, a wireless local area network (WLAN) adaptor. And the wireless reception module 124 may be selected based on the selection of the wireless transmission module 104 when the present invention is reduced to practice.

Upon the receipt of the control signal from the wireless controller 10, the power socket device 12 may determine whether to continue its power supply based on the received control signal indicative of the operating status of the main device to the socket 122 to which the auxiliary device is connected. For example, when the received control signal indicates that the main device operates routinely the power socket device 12 may continue the power supply to the corresponding socket 122 to which the auxiliary device is plugged. When the control signal indicates that the main device has been shut down or operating in the hibernation mode, the power socket device may not continue its power supply to the socket to which the auxiliary device is connected.

The power input unit 120 may be connected to a city power (not shown) in order to receive power supply from the city power as a power source. The city power could be 110-120 volts/60 Hz or 220-240 volts/50 Hz. And the sockets 122 may be including the sockets 122 that are adapted to receive the city power of 110-120 volts/60 Hz (e.g., type A or B) and the city power of 220-240 volts/50 Hz (e.g., type C, D, E, or F).

For the above-mentioned arrangement to implement, the wireless reception module 124 may need to be placed within the transmission range of the wireless transmission module 104. For example, when the wireless transmission module 104 is the RF transmission module capable of transmitting the control signal at 433.92 MHz and with the maximum transmission distance at 10 meters the wireless reception module 124 may be capable of receiving the control signal at the 433.92 MHz and placed within 10 meters of the wireless transmission module 104.

The switching unit 126, meanwhile, may switch between a power supply mode and power stoppage mode based on the received control signal. Specifically, when the received control signal is indicative of the main device is operating routinely the switching unit 126 may cause the power input unit 120 receiving the city power to be in connection with the socket to which the auxiliary device is plugged. On the other hand, the switching unit may not cause the power input unit 120 to be in connection with the socket to which the auxiliary device is connected when the received control signal indicates that the main device operates in the hibernation mode or has been shut down. It is worth noting that the auxiliary device may be a printer, a speaker, a display device, a lamp, or other home appliances.

It is worth noting that each of the sockets 122 may be independently controllable by the switching unit 126. And only the sockets 122 that are controllable by the switching unit 126 may be switched depending on the control signal. For example, assume there are five sockets 122 in total in the power socket device 12 and only the first socket 122 may operate according to the control signal. Therefore, when the control signal is indicative of the main device is in the hibernation mode or has been shut down the first socket 122 may not be caused to be in connection with the power input unit 120, while the remaining four sockets 122 are still in connection with the power input unit 120 without being controlled by the switching unit 126.

It is also worth noting that the data signal from the main device may vary depending on the operating status of the main device. In other words, the data signal generated by the main device when the main device operates routinely may be different to the data signal generated by the main device when the main device has been placed in the hibernation mode. More specifically, in one implementation the data signal may be in the form of pulses when the main device operates routinely. On the other hand, when the main device has been placed in the hibernation mode the data signal may be a signal of a zero voltage level free of pulses.

### Another Embodiment for Wireless Controller System with USB

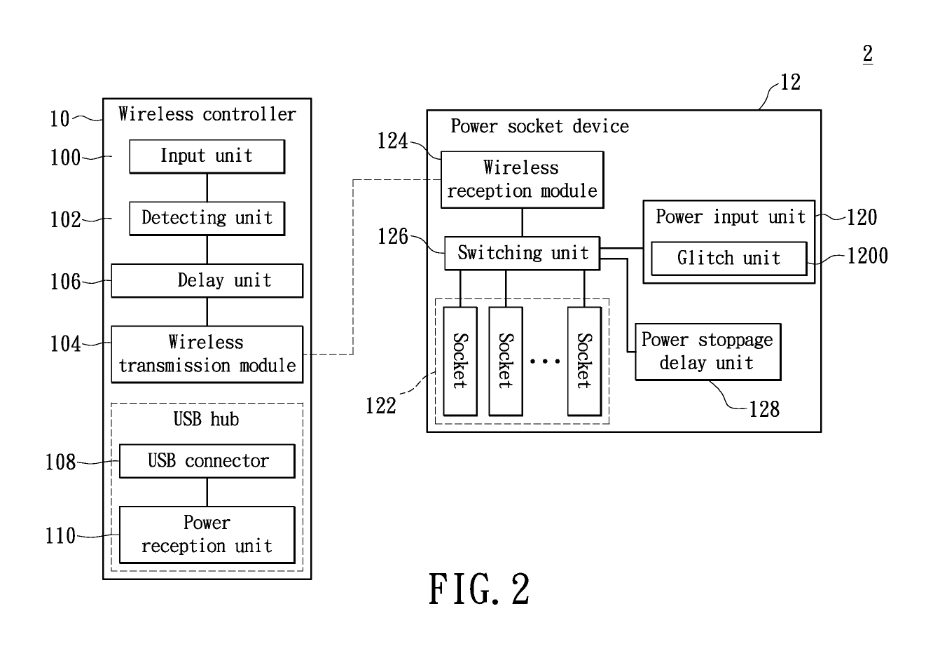

FIG. 2 is a simplified block diagram showing a wireless controller system with a USB 2 according to another embodiment of the present invention. The wireless controller system with the USB 2 when compared with the wireless controller system with the USB 1 further includes a delay unit 106, a USB connector 108, and a power reception unit 110 in the wireless controller 10, and a power stoppage delay unit 128 in the power socket device 12. The power input unit 120 of the power socket device 12 further includes a glitch unit 1200.

The delay unit 106 may be coupled between the detecting unit 102 and the wireless transmission module 104, while the USB bus connector is coupled to the power reception unit 110. Meanwhile, the power stoppage delay unit 128 may be coupled to the switching unit 126 with the glitch unit 1200 coupled between the switching unit 126 and the city power.

The delay unit 106 is configured to delay transmission of the control signal to the power socket device 12 for a predetermined period of time. With the delayed transmission of the control signal to the power socket device 12, the power supply to the auxiliary device plugged to the socket 122 of the power socket device 12 may not change too often in a short period as the result of frequent changes to the operating status of the main device. For example, when the main device has been idled for a while the main device may be placed in the standby mode, indicating the operating status of the main device changes from operating routinely to being placed in the standby, and if the main device is caused to be operating routinely immediately thereafter the operating status may change accordingly. Absent the delay unit 106, three different control signals may be generated, each of which corresponds to its respective operating status of the main device, to cause the switching unit 126 to switch from the power supply mode to the power stoppage mode and to the power supply mode again. With the delay unit 106 functioning to delay the transmission of the control signal, the switching unit 126 may not be caused to switch from one mode to another mode without waiting for the predetermined period of time. Under this arrangement, the switching unit 126 may not be caused to switch from one mode to another mode promptly, as the immediate changes to the operating status may be accidental.

The power reception unit 110 is coupled to the power source before supply the power to the USB connector 108. Thus, electronic devices coupled to the USB connector 108 may be charged. In one implementation, the power reception unit 110 may be coupled to a power line of the input unit 100 and the USB connector 108 is a USB-based connector. Under this arrangement, the electronic devices connected to the USB connector 108 may be charged by a 5-volt voltage. In another implementation, the power reception unit 110 may be coupled to the city power or the power input unit 120 and the USB connector 108 could be implemented in terms of an RS-232 connector, an RS-482 connector, an RS-422 connector, or an IEEE-1394 connector.

The USB connector 108 may help facilitate connection between the main device and the electronic devices coupled to the USB connector 108. In one implementation, when the wireless controller includes a USB hub. The USB hub includes the USB connector 108 and the power reception unit 110, and the USB connector 108 may serve as an expansion port of the USB hub. For example, the USB hub may have 4 expansion ports, the first to the third expansion ports are put into practice under the USB 2.0 standard, and the fourth expansion port is configured to serve as a charging port for receiving/transmitting power. In other words, the present invention can be considered as a wireless power-save equipment which works under the USB 2.0 standard. When the electronic device is coupled to the USB connector, the main device may be in communication with the electronic device so that both the main device and the electronic device may share files with each other through the operation of the wireless controller 10.

The power stoppage delay unit 128 may be configured to cause the auxiliary device to be stopped from being powered after a predetermined delay starting from the receipt of the control signal indicative of the switching unit 126 to be operating in the power stoppage mode. For example, when the control signal indicative of the switching unit 126 to be operating in the power stoppage mode at the time when the printer as the auxiliary device is still in the process of printing the power stoppage delay unit 128 may wait for the predetermined delay, which in one implementation may be 25 seconds, before causing the switching unit 126 to disconnect the power input unit 120 from the power socket device 122. As such, the printer as the auxiliary device could continue the process of printing without being shut down immediately after the receipt of the control signal asking for the switching unit 126 to do the same.

The glitch unit 1200 is configured to receive the city power for preventing electronic components of the wireless controller system 2 from being damaged by glitches in terms of current or voltage. The glitch unit 1200 may operate when the received city power spikes stemming from lightening. More specifically, the glitch unit 1200 may function from high impedance to low impedance when the glitches occur so that the glitches could be grounded along the path of the low impedance without being fed into main circuitry of the wireless controller 2, which may result in damages to the main circuitry of the wireless controller 2.

### Embodiment for Wireless Controller

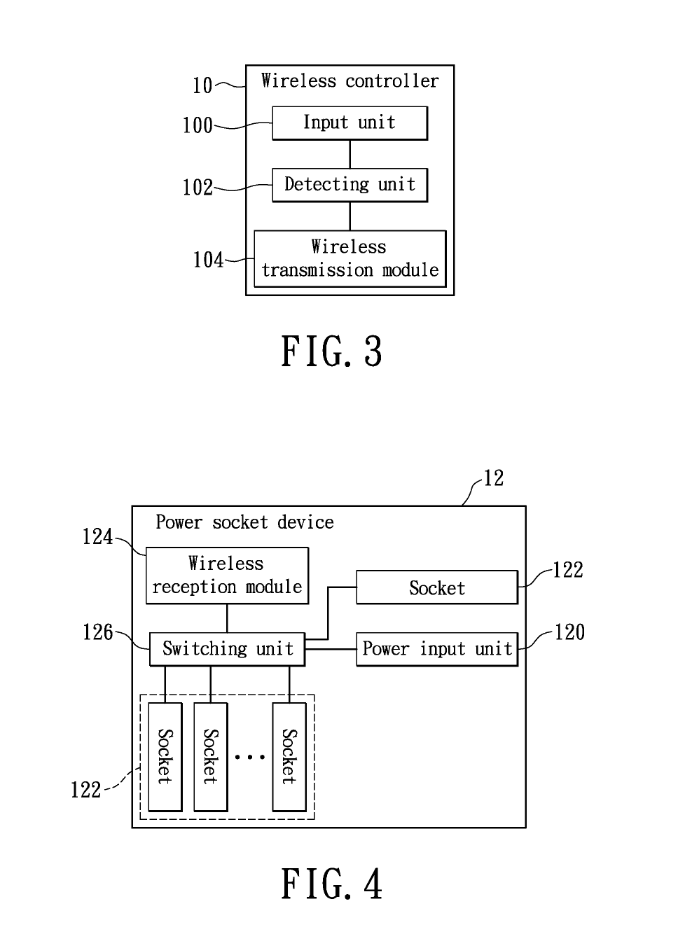

Please refer to FIG. 3 illustrating a simplified block diagram of a wireless controller with a USB 10 according to one embodiment of the present invention. The wireless controller with the USB 10 includes the input unit 100, the detecting unit 102, and a wireless transmission module 104. The detecting unit 102 is configured to detect the data signal transmitted from the main device and received by the input unit 100 before generating the corresponding control signal, which may be further transmitted by the wireless transmission module 104. The wireless controller 10 in FIG. 3 may further include the delay unit 106, the USB connector 108, and the power reception unit 110. It is worth noting that the wireless controller 10 in FIG. 3 may be implemented in terms of the wireless controllers 10 shown in FIGS. 1 and 2.

Meanwhile, the wireless controller 10 may cause the operating status of the auxiliary device to change according to the operating status of the main device. In one implementation, the auxiliary device may be the power socket device 12, a lamp, or a toy so long as the auxiliary device is equipped with the wireless reception module 124. For example, the wireless controller 10 may cause the operating status of the lamp as the auxiliary device to change based on changes to the operating status of the computer as the main device. When the data signal received by the wireless controller 10 indicates that the computer is operating routinely, the lamp may be turned on according to the corresponding control signal that causes the lamp to be turned on. On the other hand, when the computer has been placed in the hibernation mode or shut down the received data signal may cause the wireless controller 10 to dim or turn off the lamp accordingly.

FIG. 4 is a simplified block diagram illustrating a power socket device. Compared with the power socket device shown in FIG. 2, the power socket device in FIG. 4 does not have the glitch unit 1200 and the power stoppage delay unit 128.

To sum up, the wireless controller system according to the present invention may accurately detect the operating status of the main device and control the power supply to the sockets of the power socket device. And the power supply-controllable sockets may be independently controlled. As such, the sockets of the power socket device may not be powered or disconnected from the power supply indiscriminately. The wireless controller system may also control when to power or not to power the sockets of the power socket device, so that the sockets may not be subject to frequent changes to their respective power supply and the auxiliary devices coupled to the power supply-controllable sockets may get the opportunity to have ongoing tasks finished before being disconnected from the power supply as the result of the changes to the operating status of the main device. Additionally, the wireless controller system may also include connectors that are capable of charging the electronic device and the glitch unit for protecting the electronic components of the wireless control system from being damaged by glitch voltages or currents. Moreover, since the power socket device and the wireless controller system may be wirelessly communicative the power socket device may no longer in need of being placed within the proximity of the wireless controller system unless the power socket device has been beyond the range of the wireless transmission.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A wireless controller with a universal serial bus (USB), comprising:
an input unit for receiving a data signal from a main device;
a detecting unit coupled to the input unit for detecting the data signal before generating a corresponding control signal;
a wireless transmission module for transmitting the control signal; and
a USB hub, having a plurality of connectors, for facilitating a power supply to at least one electronic device compatible with the connectors;
wherein the main device and the electronic device share data through the USB hub.

2. The wireless controller with the USB according to claim 1, wherein the data signal is a differential signal of the USB.

3. The wireless controller with USB according to claim 2, wherein the wireless controller further comprises:
a power reception unit for providing the wireless controller with the power supply.

4. The wireless controller with the USB according to claim 3, wherein the wireless controller further comprises a delay unit for delaying a transmission of the control signal for a predetermined period of time.

5. A wireless controller system with a universal serial bus (USB), comprising:
a wireless controller having an input unit for receiving a data signal from a main device, a detecting unit coupled to the input unit for detecting the data signal before generating a corresponding control signal, a wireless transmission module for transmitting the control signal, and a USB hub having a plurality of connectors for facilitating a power supply to at least one electronic device compatible with the connectors; and
a power socket device having a plurality of sockets, a power input unit coupled to a city power for providing a power supply to the sockets, a wireless reception module for receiving the control signal, and a switching unit coupled to the power input unit, the sockets, and the wireless reception module for selectively connecting the power input unit and the sockets depending on the control signal, which causes the switching unit to switch between modes;
wherein the main device and the electronic device share data through the USB hub.

6. The wireless controller system according to claim 5, wherein the modes include a power supply mode and a power stoppage mode and the power input unit is connected to the socket by the switching unit when the switching unit operates in the power supply mode and the power input unit is disconnected from the socket by the switching unit when the switching unit operates in the power stoppage mode.

7. The wireless controller system according to claim 6, wherein the data signal is a differential signal of the USB.

8. The wireless controller system according to claim 7, wherein the wireless controller further comprises a power reception unit for providing the wireless controller with the power supply.

9. The wireless controller system according to claim 8, wherein the power input unit further comprises a glitch unit coupled to the city power, the socket, and the switching unit, for minimizing damages arising out of the city power as result of glitch voltages or glitch currents.

10. The wireless controller system according to claim 9, wherein the wireless controller further comprises a delay unit for delaying a transmission of the control signal for a predetermined period of time.
